(19) United States
(12) Patent Application Publication
(10) Pub. No.: US 2022/0026553 A1
(43) Pub. Date: Jan. 27, 2022

(54) NETWORKED ACOUSTIC SENSOR UNITS FOR AN ECHO-BASED ENVIRONMENT DETECTION

(71) Applicant: Robert Bosch GmbH, Stuttgart (DE)

(72) Inventor: Csaba Juhasz, Budapest (HU)

(21) Appl. No.: 17/309,719

(22) PCT Filed: Nov. 6, 2019
(86) PCT No.: PCT/EP2019/080350

§ 371 Date: Jun. 16, 2021

(51) Int. Cl. G01S 13/08; H04B 11/00

(52) U.S. Cl. CPC G01S 13/08; H04B 11/00

(57) ABSTRACT

An acoustic sensor unit for an echo-based environment detection. The acoustic sensor unit includes a transmission unit, which is set up to emit an acoustic signal, a communications interface, and a control electronics, which is set up to output a signal via the communications interface in order to transmit information to a further acoustic sensor unit and to receive a signal from the further acoustic sensor unit via the communications interface. The acoustic sensor units are connected to one another via a bus or a network node and to a central control unit.

### FIELD

The present invention relates to an acoustic sensor unit for an echo-based environment detection and to an associated system for an echo-based environment detection.

### BACKGROUND INFORMATION

Current ultrasonic sensors are actuated via a central electronic control unit, also known as ECU. To this end, each ultrasonic sensor of a sensor system is connected via a cable strand of the ultrasonic sensor to the central electronic control unit. However, this causes a considerable wiring expense for the ultrasonic sensors. In a sensor system in which, for example, twelve ultrasonic sensors are installed in a vehicle, approximately 70 meters of line wire are often required for connecting the ultrasonic sensors to the central electronic control unit. Because of the resulting long line paths, the systems including the ultrasonic sensors frequently have a slow reaction time, which is attributable to the required signal propagation times on the one hand and to a reaction time of the central control unit on the other hand.

### SUMMARY

The acoustic sensor unit for an echo-based environment detection according to an example embodiment of the present invention includes a transmission unit which is set up to emit an acoustic signal, a communications interface, and a control electronics, which is set up to output a signal via the communications interface in order to transmit information to a further acoustic sensor unit and to receive a signal from the further acoustic sensor unit via the communications interface.

The acoustic sensor unit thus is set up to transmit a signal directly to a further acoustic sensor unit without transmitting the signal via a central electronic control unit. In accordance with an example embodiment of the present invention, an acoustic sensor unit is therefore created which is capable of directly communicating with other acoustic sensor units. This shortens signal propagation times and reduces the wiring expense. For example, it is particularly not necessary in a sensor system to connect the acoustic sensor system via its own cable strand with a central electronic control unit.

The acoustic sensor unit is an ultrasonic sensor, in particular. The acoustic signal thus is preferably an ultrasonic signal. The communications interface is an interface that enables the acoustic sensor unit to emit and receive electrical signals. For this purpose, the communications interface is preferably connected to an electrical conductor via which the signals are routed. The signals are communication signals.

The control electronics is preferably an application-specific integrated circuit, or ASIC. The communications interface is preferably integrated into the control electronics. The further acoustic sensor unit is a sensor unit which preferably has the same design as the acoustic sensor unit.

With the aid of the acoustic sensor unit, a communication between two acoustic sensor units is possible. It is therefore not necessary for a central electronic control unit to control a synchronization of individual acoustic sensor units or also to merge the signals from individual acoustic sensor units.

Preferred further refinements of the present invention are disclosed herein.

In accordance with an example embodiment of the present invention, the control electronics is preferably set up to output a control signal via the communications interface in order to actuate the further acoustic sensor unit for the supply of sensor information which describes a property of the acoustic signal when it is received by the further acoustic sensor unit;

to receive the sensor information via the communications interface; to generate object information which describes a property of an object at which the acoustic signal was reflected based on the properties of the emitted acoustic signal and the sensor information; and to output the object information via the communications interface. The acoustic sensor unit is therefore suitable for controlling the echo-based environment detection. For instance, the control signal is particularly suitable for actuating the further acoustic sensor unit to receive the acoustic signal emitted by the transmission unit. The acoustic signal is typically returned to the further sensor unit following a reflection at an object so that an echo-based environment detection is able to take place by the emitting of the acoustic signal by the acoustic sensor unit and the receiving of the acoustic signal by the further acoustic sensor unit.

The control signal preferably includes information regarding a transmission time or a modulation of the acoustic signal. The sensor information describes properties of the acoustic signal when it is received by the further acoustic sensor unit. These properties may be any property of the acoustic signal, in particular a signal propagation time between the emission by the transmission unit and the receipt by the further acoustic sensor unit, a frequency or a frequency curve of the acoustic signal when it is received by the further acoustic sensor unit, or a signal strength of the acoustic signal when it is received by the further acoustic sensor unit.

In accordance with an example embodiment of the present invention, the sensor information is received by the acoustic sensor unit and processed by the control electronics. Object information is thereby generated that describes a property of the object at which the acoustic signal was reflected before it was received by the further acoustic sensor unit. For example, the control electronics calculates a distance between the acoustic sensor unit and the object and provides it as object information. Preferably, the control electronics utilizes further information for this purpose. For instance, information pertaining to a position of the further acoustic sensor unit is preferably stored in the control electronics, and the object information is calculated based on the stored position of the further acoustic sensor unit.

Furthermore, in accordance with an example embodiment of the present invention, it is preferred if the acoustic sensor unit is designed to output the control signal to multiple further acoustic sensor units, to receive from these multiple further acoustic sensor units associated sensor information in each case, and to generate the object information based on the sensor information of the multiple further acoustic sensor units.

In particular, the object information is a position of the object in relation to the acoustic sensor unit, a distance of the object from the acoustic sensor unit, or a relative velocity of the object relative to the acoustic sensor unit. Moreover, the object information preferably includes properties with regard to the object that describe a structure of the object, for instance. The object information is emitted, i.e. made available, via the communications interface. Thus, the acoustic sensor unit not only outputs sensor information but signal processing also takes place in the acoustic sensor unit. As a result, unnecessary signal propagation times can be prevented and the object information be provided in a rapid manner.

In addition, in response to a start signal received via the communications interface, the acoustic sensor unit is preferably designed to output the acoustic signal via the transmission unit, to output the control signal via the communications interface, to receive the sensor information via the communications interface, to generate the object information, and to transmit the object information via the communications interface. It is therefore possible to trigger a single measuring cycle for generating object information via the communications interface. Unnecessary measuring operations for generating the object information are therefore avoidable, and the object information particularly is supplied only when it is required.

It is also advantageous if the communications interface makes a power line communication available which provides a voltage supply of the acoustic sensor unit. For example, the communications interface in particular has only two connecting contacts via which both a voltage supply and a transmission of the signal to or from the communications interface takes place. Optionally, the communications interface has an additional ground connection. The required wiring outlay when using the acoustic sensor unit is thus further reduced.

It is also advantageous if the communications interface is a network interface. The communications interface is an Ethernet interface, in particular. This means that the communications interface supports a network protocol. For instance, the communications interface in particular supports a 100-Base-T1 or a 1000-Base-T1 protocol. A communications interface is therefore provided which has sufficient speed for communicating with the further acoustic sensor units. At the same time, it is possible to utilize conventional components for the signal routing.

The communications interface preferably is a power line communications interface which supports the network protocol. With the aid of the communications interface, a network signal is preferably converted into a power line communication, the signal transmitted via the power line communication preferably including all the information that is required according to the associated network protocol. For instance, it is possible that the acoustic sensor unit is connected to a network only via the powerline communication; in such a system, preferably at a network node, the signal output by the acoustic sensor unit via the power line communication is converted again into a network signal supported by the network node, at the connections of the network node provided for the network node. Thus, a particularly low cabling outlay is required for the acoustic sensor unit, while proven signal routing of the network node is simultaneously able to be utilized.

In accordance with an example embodiment of the present invention, it is also advantageous if the control unit is set up to transmit information that is output via the communications interface together with address information, and/or to receive such information which includes address information associated with the acoustic sensor unit via the communications interface. It is therefore possible for the acoustic sensor unit to selectively transmit information to selected further acoustic sensor units or to selectively receive information that is addressed to the acoustic sensor unit. For example, it is possible that only selected further acoustic sensor units are excited by the acoustic sensor unit with the aid of the control signal to transmit the sensor information to the acoustic sensor unit.

Furthermore, the control unit preferably generates the object information based on placement information which describes a placement of the further acoustic sensors in relation to the acoustic sensor unit, the placement information preferably being received via the communications interface. In particular, the placement information is transmitted either from the further acoustic sensor unit or from a central control unit to the acoustic sensor unit. Preferably, possible placements of the further acoustic sensor unit in relation to the acoustic sensor unit are stored in the control electronics and a selection from the possible placements for selecting the actual placement of the further acoustic sensor units in relation to the acoustic sensor unit is made using the placement information. Such placement information allows for an especially precise calculation of object information. For instance, geometrical calculations are enabled, in particular, which are carried out based on the placement of the further acoustic sensor unit in relation to the acoustic sensor unit, in particular based on the positions of the acoustic sensor unit and the further acoustic sensor unit in a vehicle.

It is also advantageous if the transmission unit is set up to receive an acoustic signal from the further acoustic sensor unit and the control electronics is set up to receive a control signal from the further acoustic sensor unit via the communications interface, and in response to the receipt of the control signal, based on the received acoustic signal from the further acoustic sensor unit, to generate sensor information that describes a property of the acoustic signal received by the acoustic sensor unit that was previously output by the further acoustic sensor unit. Furthermore, the control electronics is preferably set up to emit the sensor information via the communications interface. The acoustic sensor unit is therefore preferably set up to provide the same functions that are also provided by the further acoustic sensor unit. Thus, the acoustic sensor unit and the further acoustic sensor unit preferably have the same design. A measuring operation for generating object information is therefore able to be controlled also by the further acoustic sensor unit, the sensor information being able to be made available to the further acoustic sensor unit by the acoustic sensor unit.

A sensor system according to an example embodiment of the present invention includes at least two acoustic sensor units as described above, the sensor system furthermore having a central control unit, which is set up to receive the object information of the acoustic sensor units. In particular, the start signal is preferably provided by the central control unit and transmitted to one of the acoustic sensor units. Thus, a further unit, which, for instance, carries out further calculations based on the object information provided by the acoustic sensor units, is provided by the central control unit. As a result, labor-intensive and complex calculations do not have to be performed by each individual acoustic sensor unit but are able to be calculated in a central fashion.

Preferably, the acoustic sensor units are connected via a bus or a network node. A network node preferably is a hub or a switch. Furthermore, the hub or switch preferably includes a converter which converts a power line communication utilized by the acoustic sensor units into a communications signal that is supported by the switch or hub. Preferably, a network address or a bus address is allocated to each one of the acoustic sensor units.

### BRIEF DESCRIPTION OF THE DRAWINGS

Hereinafter, exemplary embodiments of the present invention are described in detail with reference to the figures.

FIG. 1 show an acoustic sensor unit according to an example embodiment of the present invention.

FIG. 2 show a schematic representation of a communications interface, which supports a power line communication, in accordance with an example embodiment of the present invention.

FIG. 3 shows a representation of a sensor system according to one example embodiment of the present invention.

FIG. 4 shows a schematic representation of a first step of a measuring cycle which is controlled by the acoustic sensor unit, in accordance with an example embodiment of the present invention.

FIG. 5 shows a second step of the measuring cycle, which is controlled by the acoustic sensor unit, in accordance with an example embodiment of the present invention.

### DETAILED DESCRIPTION OF EXAMPLE EMBODIMENTS

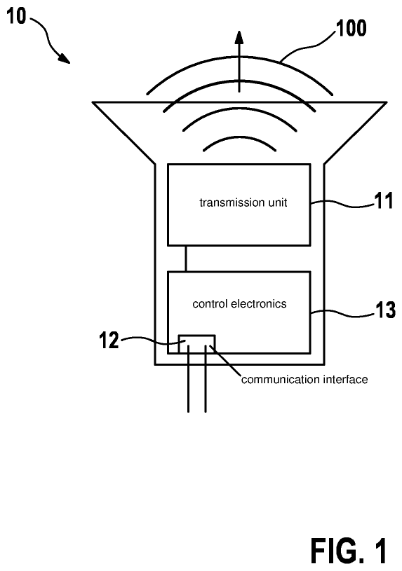

FIG. 1 shows an acoustic sensor unit 10 for an echo-based environment detection according to one embodiment of the present invention. Acoustic sensor unit 10 includes a transmission unit 11, a communications interface 12, and a control electronics 13. Control electronics 13 is an integrated switching circuit. Communications interface 12 is integrated into the integrated switching circuit and thus integrated into control electronics 13.

Transmission unit 11 is set up to emit an acoustic signal 100 when it is excited to do so by control electronics 13. Acoustic signal 100 is an ultrasonic signal, for example. Transmission unit 11 is an electro-acoustic converter.

Control electronics 13 is set up to output a signal via communications interface 12 in order to transmit information to a further acoustic sensor unit 20, 30 and to receive a signal from further acoustic sensor unit 20, 30 via the communications interface. This means that acoustic sensor unit 10 is designed to communicate with a further acoustic sensor unit 20, 30.

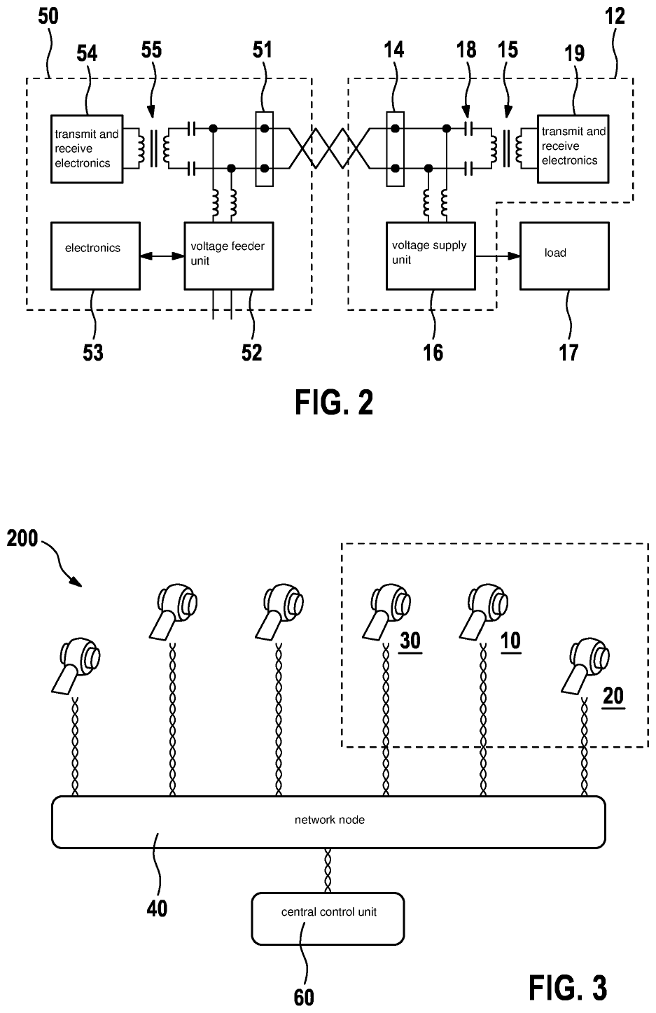

A power line communication is provided by communications interface 12. A voltage supply for acoustic sensor unit 10 is thereby provided via communications interface 12. An exemplary communications interface 12 is shown in FIG. 2. Communications interface 12 is connected to a further communications interface 50 in FIG. 2, by which a supply voltage of the power line communication is made available. Further communications interface 50 is particularly included by a network node 40 or by a central control unit 60. Optionally, it is therefore possible that the further acoustic sensor units 20, 30 are also coupled between further communications interface 50 and communications interface 12 of acoustic sensor unit 10.

Communications interface 12 shown in FIG. 2 has an input connection 14, which has a first pole and a second pole. Optionally, communications interface 12 has a third connection via which communications interface 12 and/or acoustic sensor unit 10 is/are connected to ground. The first pole and the second pole of the input connection are coupled via a respective inductivity to a voltage supply unit 16 in each case. Through voltage supply unit 16, the voltage supplied via input connection 14, in particular a direct voltage having a signal modulated thereon, is converted into a supply voltage, which in turn is supplied to the electronic components of acoustic sensor unit 10 as supply voltage. The electronic components of acoustic sensor unit 10 are shown as a load 17 in FIG. 2. Load 17 in particular includes control electronics 13 and transmission unit 11.

In the described example, a direct voltage onto which a signal is modulated is output by further communications interface 50. In order to decouple the signal from the supply voltage, communications interface 12 includes an inductive coupling element 15 in which an input coil is inductively coupled with an output coil. Each connection of the input coil is coupled with a pole of input connection 14 via a respective capacity. Thus, only the signal modulated onto the direct voltage is transmitted via inductive coupling element 15 to a transmit and receive electronics 19 which is coupled with the connections of the output coil. This signal component is the signal that is received via communications interface 12 in order to communicate with the further acoustic sensor units 20, 30 or with control unit 60. In the reverse, transmit and receive electronics 19 is also able to modulate a signal onto the direct voltage applied at input connection 14 in order to transmit a signal to central control unit 60 or to further acoustic sensor units 20, 30.

The structure of further communications interface 50 essentially corresponds to the structure of communications interface 12. However, instead of voltage supply unit 16, a voltage feeder unit 52 is provided. Voltage feeder unit 52 is coupled with an external voltage supply which provides it with a 12V direct voltage, for instance. Voltage feeder unit 52 provides the supply voltage intended for acoustic sensor unit 10 via an output connection 51 of further communications interface 50, which is coupled with the two poles of input connection 14 of communications interface 12. In addition, an electronics 53 of central control unit 60 or of network node 40 is also supplied with an operating voltage via voltage feeder unit 52. Similar to transmit and receive electronics 19 of communications interface 12, a transmit and receive electronics 54 is also situated in further communications interface 50, which enables network node 40 or central control unit 60 to modulate a desired signal onto the supply voltage. For instance, a direct voltage, e.g., 12V, is supplied via the poles of output connection 51, and the signal to be transmitted to acoustic sensor unit 10 is modulated onto this direct voltage with the aid of transmit and receive electronics 54 of further communications interface 50 and an inductive coupling unit 55 of further communications interface 50. In a corresponding manner, transmit and receive electronics 54 of further communications interface 50 is also able to receive a signal that was modulated onto the direct voltage by acoustic sensor unit 10 with the aid of communications interface 12.

Communications interface 12 especially is also a network interface. In particular, communications interface 12 is connected via network node 40 to central control unit 60 and to further acoustic sensor unit 20, 30. Network node 40 is a switch or a hub, in particular, which is coupled with central control unit 60.

A sensor system 200 according to one example embodiment of the present invention is shown in FIG. 3. Sensor system 200 includes a multitude of acoustic sensor units 10, 20, 30 of which exemplarily six acoustic sensor units are shown in FIG. 3. One sensor unit of the multitude of acoustic sensor units is acoustic sensor unit 10. In addition to acoustic sensor unit 10, sensor system 200 encompasses a first further acoustic sensor unit 20 and a second further acoustic sensor unit 30. Each of the acoustic sensor units 10, 20, 30 is connected to network node 40. Network node 40 is furthermore connected to central control unit 60. Network node 40 in this exemplary embodiment is a hub. This means that any signal that is transmitted from acoustic sensor unit 10 via communications interface 12 to the hub is forwarded by this hub 40 to each of the further acoustic sensor units 20, 30 and is also forwarded to central control unit 60.

Thus, a network is created by acoustic sensor units 10, 20, 30, network nodes 40, and central control unit 60. In order to enable an addressing of acoustic sensor units 10, 20, 30 and central control unit 60 in this network, information that is output by control unit 13 via communications interface 12 is transmitted together with address information. The address information is a network address, in particular. Such a network address is assigned to each of the acoustic sensor units 10, 20, 30 and central control unit 60. Thus, information output by acoustic sensor unit 10 is selectively transmittable to one of the further acoustic sensor units 20, 30 or to central control unit 60. Address information accordingly is also allocated to acoustic sensor unit 10, which means that acoustic sensor unit 10 has its own network address. Acoustic sensor unit 10 receives such information having the address information associated with acoustic sensor unit 10 via communications interface 12. Essentially, the protocol known as the Ethernet protocol for automotive applications is used for this purpose. Exemplary protocols are the protocols used for the 100Base-T1 or 1000Base-T1. Sufficient bandwidth is therefore provided. By combining this protocol with the power line communication, also known as power-over-data line, PODL, a supply voltage can be supplied to acoustic sensor units 10, 20, 30 via a twisted cable pair in each case and a communication with the rest of the network is also able to be conducted via this cable. In particular a supply with a 12 Volt direct voltage is provided for acoustic sensor unit 10 with the aid of the power line communication, this supply especially being a 5 Watt supply.

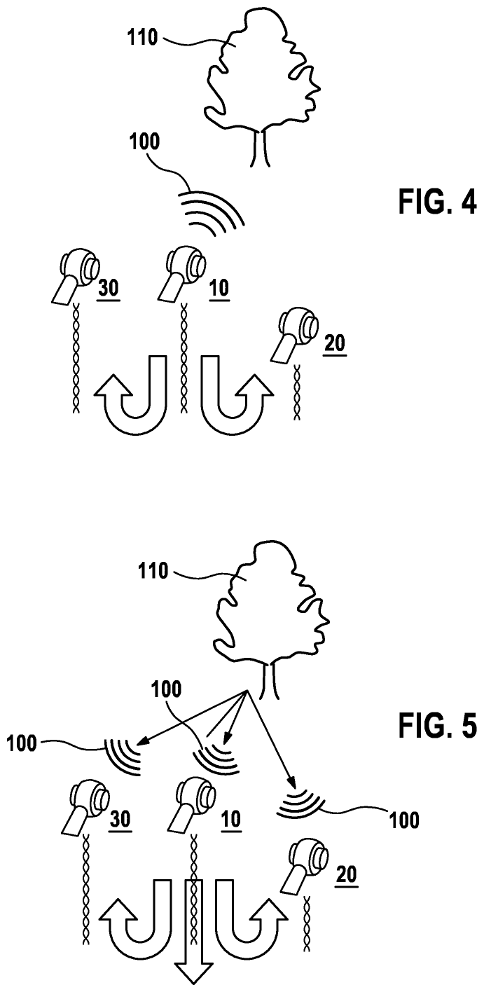

Acoustic sensor unit 10 is suitable for controlling a measuring cycle which is executed by acoustic sensor unit 10 and further acoustic sensor units 20, 30. After this measuring cycle, object information is output via communications interface 12, the object information preferably being transmitted to central control unit 60. The two steps of such a measuring cycle are shown in FIGS. 4 and 5.

The measuring cycle is started in that central control unit 60 transmits a start signal to acoustic sensor unit 10. When the start signal is received by acoustic sensor unit 10, then control electronics 13 excites transmission unit 11 to emit an acoustic signal 100. Acoustic signal 100 is an ultrasonic signal. At the same time, control electronics 13 outputs a control signal via communications interface 12 in order to actuate first and second further acoustic sensor unit 20, 30 for the purpose of supplying sensor information that describes a property of acoustic signal 100 when it is received from respective further acoustic sensor unit 20, 30. This step is shown in FIG. 4. It is not necessary here for all acoustic sensor units of the network to supply sensor information and to transmit it to acoustic sensor unit 10. Because of the possibility of addressing the individual acoustic sensor units of the network, and thus the further acoustic sensor units 20, 30, acoustic sensor unit 10 is able to selectively choose which ones of the acoustic sensor units of the network, and thus of sensor system 200, supply sensor information.

For example, the further acoustic sensor units 20, 30 ascertain a signal propagation time of acoustic signal 100 in each case and transmit it as sensor information to acoustic sensor unit 10. Optionally, the signal propagation time is ascertained based on a transmission instant of the control signal. Control electronics 30 receives the signal propagation time as sensor information via communications unit 12. It is pointed out that the signal propagation time has been selected here as sensor information simply by way of an example. Alternatively or additionally, other sensor information can be received from further acoustic sensor units 20, 30 by way of communications interface 12. A signal intensity, a receiving direction and a signal frequency of acoustic signal 100 during its reception are examples of additional exemplary information.

Based on the properties of emitted acoustic signal 100 and the sensor information, object information is generated which describes a property of an object 110 at which acoustic signal 100 was reflected. For example, the property of the emitted acoustic signal is a transmission instant at which acoustic signal 100 was output. The sensor information, for example, is a signal propagation time of acoustic signal 100 or also only a receiving instant of acoustic signal 100 at further acoustic sensor unit 20, 30. Preferably, the property of emitted acoustic signal 100 is included by the sensor information. The object information is calculated based on the sensor information supplied to control electronics 13 by further acoustic sensor units 20, 30 and is preferably calculated on the basis of information that is made available to control electronics via transmission unit 11. Thus, sensor unit 11 is preferably also suitable for receiving an echo of acoustic signal 100 which it had previously output. Acoustic sensor unit 10 is thereby also suitable for autonomously carrying out an echo-based environment detection, in which transmission unit 11 emits acoustic signal 100 and an echo of acoustic signal 100 is received and, for instance, properties of object 110 at which acoustic signal 100 was reflected are inferred based on a propagation time of acoustic signal 100. This object information may be made more precise by considering the sensor information that was received from further acoustic sensor units 20, 30 via communications interface 12. For instance, based on a signal propagation time starting from acoustic sensor unit 10 to further acoustic sensor units 20, 30 and to acoustic sensor unit 10, a position of object 110 relative to acoustic sensor unit 10 is able to be inferred. On the basis of different signal propagation times, for example, a triangulation may be performed. Thus, the object information preferably is a position of object 110 in relation to acoustic sensor unit 10.

In this context it is advantageous if control unit 13 generates the object information based on placement information, which describes a placement of further acoustic sensor units 20, 30 in relation to acoustic sensor unit 10. This means that control electronics 13 preferably is aware of a placement of further acoustic sensor unit 20, 30. Based on geometrical calculations, it is therefore possible to calculate the position of object 110 in relation to acoustic sensor unit 10. The placement information is stored in control electronics 13 or is also received via communications interface 12. The placement information is preferably provided to control electronics 13 by central control unit 60.

It is pointed out that the object information does not necessarily describe a position of object 110. As an alternative, the object information describes a distance between the object and acoustic sensor unit 10, a surface characteristic of object 110, or a relative velocity of object 110 in relation to acoustic sensor unit 10.

When the object information was generated, i.e., calculated, by control electronics 13, then the object information is output via communications interface 12. This step is shown in FIG. 5. The object information is preferably transmitted to central control unit 60. However, the object information may also be provided to others of the acoustic sensor units of sensor system 200 in order to enable them to carry out an additional advantageous calculation of additional object information.

Thus, it follows that acoustic sensor unit 10 emits acoustic signal 100 via transmission unit 11 in response to the receipt of the start signal, outputs the control signal via communications interface 12, receives the sensor information via communications interface 12, generates the object information and transmits the object information via communications interface 12. Thus, only a single signal is received by acoustic sensor unit 10 and in response to this signal, which already describes properties of the object and is not merely restricted to sensor information, object information is provided. The corresponding signal processing is carried out by acoustic sensor unit 10 and therefore no longer has to be performed by central control unit 60.

Acoustic sensor units 10, 20, 30 of the sensor system are acoustic sensor units of the same design. This means that, depending on the acoustic sensor units 10, 20, 30 to which the start signal is transmitted, the corresponding sensor unit 10, 20, 30 controls the measuring cycle. For this reason, acoustic sensor unit 10 is also set up to receive an acoustic signal from further acoustic sensor unit 20, 30, and control electronics 13 is furthermore set up to receive a control signal from further acoustic sensor unit 20, 30 via communications interface 12, and in response to the receipt of the control signal and based on received acoustic signal 100 from further acoustic sensor unit 20, 30, to generate sensor information which describes a property of the received acoustic signal, and to output the sensor information via communications interface 12. The sensor system according to the present invention therefore makes it possible that only a start signal is required and an associated measuring cycle is executed and coordinated by one of acoustic sensor units 10, 20, 30. Coordinates that define a placement of individual acoustic sensor units 10, 20 are preferably taken into account in the process.

In further preferred embodiments of the present invention, information from other acoustic sensor units 20, 30 is selectively obtained by acoustic sensor unit 10 in order to enable an object identification. For instance, this makes it possible in further measuring cycles to selectively actuate further acoustic sensor units 20, 30 or to selectively actuate other acoustic sensor units for the purpose of supplying sensor information. The object information may thus also be generated based on multiple measuring cycles. An object identification which is controlled by acoustic sensor unit 10 can therefore also be carried out. Preferably, central control unit 60 thus only sends a query for an object identification to acoustic sensor unit 10 by the start signal, and acoustic sensor unit 10 supplies as object information the detected object, for instance based on an object type or object coordinates. However, this does not exclude further processing of the object information by central control unit 60 based on other sensor information that, for instance, is provided via another sensor system, e.g., an environment camera. Optionally, such further sensor systems are likewise coupled with central control unit 60 via network node 40.

Typically, acoustic sensor unit 10 which outputs acoustic signal 100 is therefore preferably responsible for an object detection. Based on the placement information, acoustic sensor unit 10 is able to detect which of the further acoustic sensor units 20, 30 is capable of providing sensor information that is required for scanning an object 110. Accordingly, this sensor information is queried from further acoustic sensor units 20, 30, and the echoes received by further acoustic sensor units 20, 30 are supplied to acoustic sensor unit 10. As soon as all information of acoustic sensor unit 10 and further acoustic sensor units 20, 30 has been incorporated into the object information to be generated, the object information is made available.

In alternative embodiments, acoustic sensor units 10, 20, 30 are connected to one another via a bus system. In this case, network node 40 is no longer required. This allows for a particularly simple design of the sensor system.

In addition to the above disclosure, explicit reference is made to the disclosure of FIGS. 1 through 5.

1-10. (canceled)

11. An acoustic sensor unit for an echo-based environment detection, comprising:
a transmission unit configured to emit an acoustic signal;
a communications interface; and
a control electronics configured to:
output a signal via the communications interface in order to transmit information to a further acoustic sensor unit, and
receive a signal from the further acoustic sensor unit via the communications interface.

12. The acoustic sensor unit as recited in claim 11, wherein the control electronics is configured to:
output a control signal via the communications interface to actuate the further acoustic sensor unit to supply sensor information which describes a property of the acoustic signal when the acoustic signal is received by the further acoustic sensor unit;
receive sensor information via the communications interface;
generate object information which describes a property of an object at which the acoustic signal was reflected based on properties of the emitted acoustic signal and the sensor information; and
output the object information via the communications interface.

13. The acoustic sensor unit as recited in claim 12, wherein in response to a start signal received via the communications interface, the acoustic sensor unit is configured to:
output the acoustic signal via the transmission unit;
output the control signal via the communications interface;
receive the sensor information via the communications interface;
generate the object information; and
transmit the object information via the communications interface.

14. The acoustic sensor unit as recited in claim 11, wherein the communications interface makes a power line communication available, which provides a voltage supply of the acoustic sensor unit.

15. The acoustic sensor unit as recited in claim 11, wherein the communications interface is an Ethernet interface.

16. The acoustic sensor unit as recited in claim 11, wherein the control electronics is configured to transmit information that is output via the communications interface together with address information, and/or to receive the information which includes address information associated with the acoustic sensor unit via the communications interface.

17. The acoustic sensor unit as recited in claim 12, wherein the control electronics is configured to generate the object information based on placement information which describes a placement of the further acoustic sensor unit in relation to the acoustic sensor unit.

18. The acoustic sensor unit as recited in claim 17, wherein the placement information is received via the communications interface.

19. The acoustic sensor unit as recited in claim 11, wherein:
the transmission unit is configured to receive an acoustic signal from the further acoustic sensor unit; and
the control electronics is configured to receive a control signal from the further acoustic sensor unit via the communications interface, and in response to receipt of the control signal, to generate sensor information which describes a property of the received acoustic signal based on the received acoustic signal of the further acoustic sensor unit, and to output the sensor information via the communications interface.

20. A sensor system, comprising:
at least two acoustic sensor units, each of the acoustic units including:
a transmission unit configured to emit an acoustic signal;
a communications interface;
a control electronics configured to:
output a signal via the communications interface in order to transmit information to a further acoustic sensor unit,
receive a signal from the further acoustic sensor unit via the communications interface,
output a control signal via the communications interface to actuate the further acoustic sensor unit to supply sensor information which describes a property of the acoustic signal when the acoustic signal is received by the further acoustic sensor unit,
receive sensor information via the communications interface,
generate object information which describes a property of an object at which the acoustic signal was reflected based on properties of the emitted acoustic signal and the sensor information, and
output the object information via the communications interface; and
a central control unit configured to receive the object information of the acoustic sensor units.

21. The sensor system as recited in claim 20, wherein the acoustic sensor units are connected to each other via a bus or a network node.
